(19) United States
(12) Patent Application Publication
(10) Pub. No.: US 2009/0131066 A1
(43) Pub. Date: May 21, 2009

(54) TECHNIQUES FOR IMPROVING CHANNEL QUALITY ESTIMATES IN WIRELESS COMMUNICATION SYSTEMS

(75) Inventors: Satyen D. Barve, Palatine, IL (US); Aravind N. Nunsavathu, Bloomingdale, IL (US); Jun Wang, Evanston, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/943,138

(22) Filed: Nov. 20, 2007

(51) Int. Cl. H04Q 7/20

(52) U.S. Cl. 455/452.2

(57) ABSTRACT

A technique for operating a wireless communication device includes determining mobility of a subscriber station. A channel quality indicator averaging parameter is then adjusted based on the mobility of the subscriber station.

### BACKGROUND

1. Field

This disclosure relates generally to wireless communication systems and, more specifically, to techniques for improving channel quality estimates in wireless communication systems

2. Related Art

In general, orthogonal frequency division multiplexing (OFDM) systems support high data rate wireless transmission using orthogonal channels, which offer immunity against fading and inter-symbol interference (ISI) usually without requiring implementation of elaborate equalization techniques. Typically, OFDM systems split data into N streams, which are independently modulated on parallel spaced subcarrier frequencies or tones. The frequency separation between subcarriers is 1/T, where T is the OFDM symbol time duration. Each symbol may include a guard interval (or cyclic prefix) to help maintain the orthogonality of the symbols. Typically, OFDM systems have utilized an inverse discrete Fourier transform (IDFT) to generate a sampled (or discrete) composite time-domain signal.

In general, wireless networks have used an estimated received signal strength and an estimated carrier to interference and noise ratio (CINR) of a received signal to determine operational characteristics of the networks. As one example, IEEE 802.16e (commonly known as wireless interoperability for microwave access (WiMAX)) compliant mobile stations are required to estimate a received signal strength indicator (RSSI) and a CINR of a received signal. In general, CINR at a mobile station (MS) may be calculated as the ratio of an RSSI of a serving base station (BS) to summed RSSIs of non-serving BSs added to a white noise power of a receiver of the MS. The RSSI associated with a serving BS may be used by an MS for uplink power control and the CINR, which is reported to a serving BS, may be used by the serving BS to adapt a modulation and coding scheme (MCS) to link conditions. That is, a serving BS may use a reported channel quality indicator (CQI), that is based on a CINR at an MS, to select an appropriate MCS for communications with the MS.

Accurate reported CINRs are usually desirable, as inaccurate reported CINRs may impact performance of a wireless communication system. For example, reporting a CINR that is above an actual CINR may decrease system throughput due to frame re-transmission, while reporting a CINR that is below the actual CINR may cause the serving BS to schedule data rates below a supportable data rate. According to IEEE 802.16e, RSSI and CINR estimates at an MS are derived based on a preamble signal, which is an orthogonal frequency division multiple access (OFDMA) symbol that is transmitted at the beginning of each OFDMA frame.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a flowchart of an example process that adjusts a channel quality indicator (CQI) averaging parameter based on mobility of a subscriber station (SS), according to an embodiment of the present disclosure.

FIG. 2 is a flowchart of an example process that determines and reports a CQI based on a received CQI averaging parameter, according to an embodiment of the present disclosure.

FIG. 3 is a block diagram of an example wireless communication system that may adjust a CQI averaging parameter according to various aspects of the present disclosure.

### DETAILED DESCRIPTION

In the following detailed description of exemplary embodiments of the invention, specific exemplary embodiments in which the invention may be practiced are described in sufficient detail to enable those of ordinary skill in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims and their equivalents.

While the discussion herein is generally directed to a WiMAX compliant wireless communication system, it should be appreciated that the techniques disclosed herein are broadly applicable to wireless communication systems that employ an averaging parameter to average a reported channel quality indicator (CQI). More specifically, the techniques disclosed herein are broadly applicable to any wireless communication system where channel quality reported by a subscriber station (SS), to an access point (AP) that controls channel quality measurements, is used by the AP to select a channel appropriate modulation and coding scheme (MCS). The terms “access point” and “base station,” as used herein, are synonymous. As used herein, the term “coupled” includes both a direct electrical connection between blocks or components and an indirect electrical connection between blocks or components achieved using intervening blocks or components.

Channel quality indicator channel (CQICH) allocation (i.e., fast-feedback channel allocation) may be adjusted based on a variance of a channel quality indicator (CQI) received from a subscriber station (SS), e.g., a mobile station (MS). However, depending upon a selected CQI averaging parameter, a reported CQI may not (even when reported more frequently in time) accurately reflect current radio frequency (RF) channel conditions. According to various aspects of the present disclosure, employing a higher selected averaging parameter for a fast-moving MS generally increases the accuracy of a reported CQI (e.g., a reported CINR). As used herein, the term “fast-moving MS” is a relative term that indicates that the MS is moving at a rate of speed that is above a selected speed threshold (e.g., zero miles per hour (MPH)). As noted above, as a reported CQI is utilized by a serving BS to select an appropriate modulation and coding scheme (MCS), reporting an accurate CQI facilitates the selection of an appropriate MCS by a scheduler of the serving BS, or a scheduler (e.g., a network scheduler) in communication with the serving BS. The techniques disclosed herein are broadly applicable to wireless communication systems in which a serving BS performs scheduling (based on a reported CQI) and to wireless communication systems in which a network scheduler that is coupled to a serving BS performs scheduling (based on a reported CQI).

According to various aspects of the present disclosure, channel quality reported by a subscriber station (e.g., a fast-moving MS) is averaged over time as given by the following equation:

CINRavg(n)=10 log(α10^{CINR(n)/10}+(1−α)10^{CINRavg(n-1)/10})

where CINR(n) represents a current CINR measurement performed at an SS; α represents a CINR averaging parameter (or filter coefficient) provided from a serving BS to the SS; and CINRavg(n−1) represents an average of a selected number (e.g., ten) of previous CINR measurements performed at the SS. The CQI (in this case, CINR) averaging parameter may be a broadcast parameter with a relatively low value (e.g., 0.5, 0.25) for slow-moving or stationary MSs. Employing a relatively low value for the CQI averaging parameter for slow-moving or stationary MSs usually smoothes out instantaneous and short-lived radio frequency (RF) channel fluctuations.

According to one or more aspects of the present disclosure, the value of the CQI averaging parameter is set to a relatively high value (e.g., about 0.9) to weight a reported CQI toward a current CQI for fast-moving MSs. As one example, the CQI averaging parameter may be modified at run-time by sending a broadcast message (e.g., a downlink channel descriptor (DCD) message) from a serving BS in a unicast manner to control the accuracy of a CQI report on a fast-feedback channel (e.g., a channel quality information channel (CQICH)). In certain situations it may be more desirable to employ a CQICH allocation information element (IE) to adjust a CQI averaging parameter when a DCD message does not provide a desired adjustment frequency. In general, a CQICH allocation IE, which is a unicast IE that is carried in an uplink (UL) map transmitted from a serving BS, has a relatively small size (around eight bytes, as compared to around one-hundred thirty-nine bytes for a DCD message) and may be transmitted relatively frequently (usually in no more than about one in every three to five frames as contrasted with about one in every two-thousand to five-thousand frames for a DCD message).

Changes to the CQI averaging parameter may be conditionally triggered based on, for example, mobility support (which is negotiated when an SS enters a network), downlink (DL) automatic repeat request (ARQ) window stall, or DL hybrid automatic repeat request (HARQ) negative acknowledgements. The DL ARQ window stall and DL HARQ negative acknowledgements may be thresholded to reduce the possibility of over-correction of the CQI averaging parameter. A CQI report frequency may also be modified based on mobility support, DL ARQ window stall, DL HARQ negative acknowledgements, or some combination thereof. For example, an existing CQICH may be reallocated or another CQICH (having a higher frequency than the existing CQICH) may be allocated using a CQICH allocation information element (IE).

According to one aspect of the present disclosure, a technique for operating a wireless communication device (e.g., a serving base station) includes determining mobility of a subscriber station. A channel quality indicator averaging parameter is then adjusted based on mobility of the subscriber station.

According to another aspect of the present disclosure, a technique for operating a subscriber station (SS) includes receiving a channel quality indicator (CQI) averaging parameter whose value is based on mobility of the SS. A CQI report is then transmitted on a fast-feedback channel. A frequency of the CQI report is based on the mobility of the SS (e.g., a fast-moving SS reports CQI more frequently than a slow-moving SS).

According to a different aspect of the present disclosure, a wireless communication system includes a subscriber station (SS) and a base station (BS) in communication with the SS. The BS is configured to determine mobility of the SS and adjust a channel quality indicator averaging parameter based on the mobility of the SS.

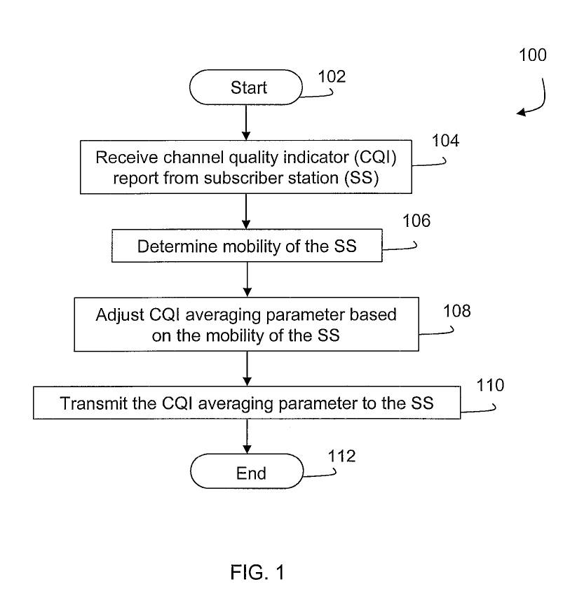

Moving to FIG. 1, an example process 100 is illustrated that adjusts a channel quality indicator (CQI) averaging parameter (e.g., a CINR averaging parameter) based on mobility of a subscriber station (SS). In block 102 the process 100 is initiated, at which point control transfers to block 104. In block 104, a CQI report is received (at a serving BS) from a served SS. Next, in block 106, the BS determines the mobility of the SS. As previously noted, the mobility of the SS may be determined, for example, based on mobility support (as requested by the SS at network entry), DL ARQ window stall, DL HARQ negative acknowledgements, some combination thereof, or other factors.

Then, in block 108, the BS employing a scheduler (or a network scheduler) adjusts the CQI averaging parameter for the SS based on the mobility of the SS. As noted above, the BS also selects an appropriate modulation and coding scheme (MCS) for the SS, based on the reported CQI. Next, in block 110, the BS transmits the CQI averaging parameter to the SS. The CQI averaging parameter may be transmitted to the SS in a downlink descriptor (DCD) message or a channel quality indicator channel (CQICH) allocation information element (IE), depending on the speed of the SS. Following block 110, the process 100 terminates in block 112, at which point control returns to a calling routine.

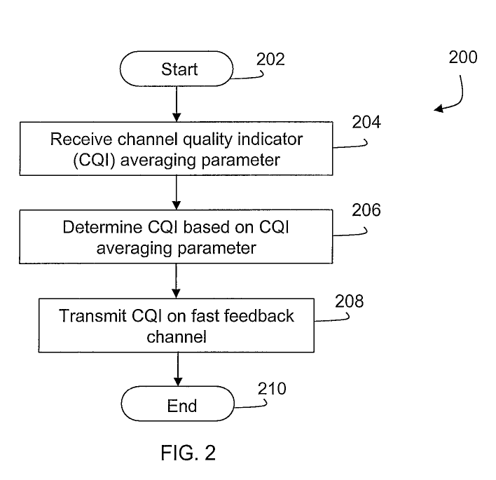

Turning to FIG. 2, an example process 200 is illustrated that is executed by a subscriber station (SS) to determine a channel quality indicator (CQI). The CQI reported from the SS to a serving base station (BS) is based on a CQI averaging parameter (e.g., a CINR averaging parameter) provided by the serving BS to the SS. As noted above, the CQI averaging parameter is based on mobility of the SS. As above, the mobility of the SS may be determined, for example, based on mobility support (as requested by the SS at network entry), DL ARQ window stall, DL HARQ negative acknowledgements, some combination thereof, or other factors. In block 202 the process 200 is initiated, at which point control transfers to block 204.

In block 204, the SS receives the CQI averaging parameter from the serving BS. The CQI averaging parameter may be transmitted to the SS in, for example, a downlink descriptor (DCD) message or a channel quality indicator channel (CQICH) allocation information element (IE). Next, in block 206, the SS determines the CQI (using, for example, the equation set forth above) based on the CQI averaging parameter received from the serving BS. Then, in block 208, the SS transmits (reports) the CQI to the serving BS on a fast-feedback channel (e.g., the CQICH). As noted above, a scheduler in the serving BS (or a network scheduler in communication with the serving BS) uses the reported CQI to select an appropriate modulation and coding scheme (MCS) for the SS. Following block 208, the process 200 terminates in block 210, at which point control returns to a calling routine.

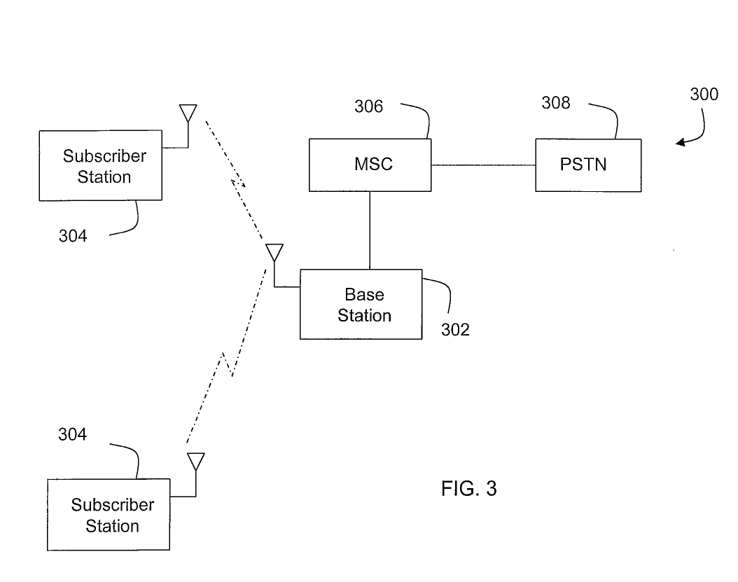

With reference to FIG. 3, an example wireless communication system 300 includes multiple subscriber stations (SSs) 304, e.g., mobile stations (MSs), that are configured to communicate with another device via a serving base station (BS) 302. According to various aspects of the present disclosure, the BS 302 may be configured to adjust a channel quality indicator averaging parameter based on mobility of the SSs 304. The SSs 304 may transmit/receive various information, e.g., voice, images, video, and audio, to/from various sources, e.g., another SS, or an internet-connected server, and may travel at different speeds. As is depicted, the BS 302 is coupled to a mobile switching center (MSC) 306, which is coupled to a public switched telephone network (PSTN) 308. Alternatively, the system 300 may not employ the MSC 306 when voice service is based on voice over Internet protocol (VoIP) technology, where calls to the PSTN 308 are typically completed through a gateway (not shown).

The BS 302 includes a transmitter and a receiver (not individually shown), both of which are coupled to a control unit (not shown), which may be, for example, a microprocessor, a microcontroller, a programmable logic device (PLD), or an application specific integrated circuit (ASIC) that is configured to execute a software system to perform at least some of the various techniques disclosed herein. Similarly, the SSs 304 includes a transmitter and a receiver (not individually shown) coupled to a control unit (not shown), which may be, for example, a microprocessor, a microcontroller, a PLD, or an ASIC that is configured to execute a software system to perform the various techniques disclosed herein. The control unit may also be coupled to a display (e.g., a liquid crystal display (LCD)) and an input device (e.g., a keypad).

Accordingly, techniques have been disclosed herein that generally improve the selection of an appropriate modulation and coding scheme for communications between a serving base station and a subscriber station, e.g., a mobile station, based upon mobility of the subscriber station.

As used herein, a software system can include one or more objects, agents, threads, subroutines, separate software applications, two or more lines of code or other suitable software structures operating in one or more separate software applications, on one or more different processors, or other suitable software architectures.

As will be appreciated, the processes in preferred embodiments of the present invention may be implemented using any combination of computer programming software, firmware or hardware. As a preparatory step to practicing the invention in software, the computer programming code (whether software or firmware) according to a preferred embodiment is typically stored in one or more machine readable storage mediums, such as fixed (hard) drives, diskettes, optical disks, magnetic tape, semiconductor memories (e.g., read-only memories (ROMs), programmable ROMs (PROMs), etc.), thereby making an article of manufacture in accordance with the invention. The article of manufacture containing the computer programming code is used by either executing the code directly from the storage device, by copying the code from the storage device into another storage device, such as a hard disk, random access memory (RAM), etc., or by transmitting the code for remote execution. The method form of the invention may be practiced by combining one or more machine-readable storage devices containing the code according to the present disclosure with appropriate standard computer hardware to execute the code contained therein.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included with the scope of the present invention. Any benefits, advantages, or solution to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method of operating a wireless communication device, comprising:
determining mobility of a subscriber station; and
adjusting a channel quality indicator averaging parameter based on the mobility of the subscriber station.

2. The method of claim 1, further comprising:
transmitting the channel quality indicator averaging parameter to the subscriber station.

3. The method of claim 1, further comprising:
transmitting the channel quality indicator averaging parameter to the subscriber station each first time interval when the mobility of the subscriber station is above a first threshold; and
transmitting the channel quality indicator averaging parameter to the subscriber station each second time interval when the mobility of the subscriber station is below the first threshold, wherein the second time interval is longer than the first time interval.

4. The method of claim 1, wherein the determining mobility of a subscriber station further comprises:
determining the mobility of the subscriber station based on whether the subscriber station indicates mobility support is required.

5. The method of claim 1, wherein the determining mobility of a subscriber station further comprises:
determining the mobility of the subscriber station based on a frequency of downlink automatic repeat request window stall.

6. The method of claim 1, wherein the determining mobility of a subscriber station further comprises:
determining the mobility of the subscriber station based on a frequency of downlink hybrid automatic repeat request negative acknowledgement.

7. The method of claim 1, further comprising:
receiving a channel quality indicator report, wherein a frequency of the channel quality indicator report is based on mobility support, a frequency of downlink automatic repeat request window stall, or a frequency of downlink hybrid automatic repeat request negative acknowledgement.

8. The method of claim 1, wherein the adjusting a channel quality indicator averaging parameter based on the mobility of the subscriber station further comprises:
increasing the channel quality indicator averaging parameter when the mobility of the subscriber station increases.

9. The method of claim 1, further comprising:
transmitting the channel quality indicator averaging parameter to the subscriber station in a downlink channel descriptor message or a channel quality indicator channel allocation information element.

10. A method of operating a subscriber station, comprising:
receiving a channel quality indicator averaging parameter whose value is based on mobility of the subscriber station; and
transmitting a channel quality indicator report on a fast-feedback channel, wherein a frequency of the channel quality indicator report is based on the mobility of the subscriber station.

11. The method of claim 10, wherein the mobility of the subscriber station is based on at least one of mobility support, a frequency of downlink automatic repeat request window stall, and a frequency of downlink hybrid automatic repeat request negative acknowledgement.

12. The method of claim 10, further comprising:
transmitting the channel quality indicator report to a base station each first time interval when the mobility of the subscriber station is above a first threshold; and
transmitting the channel quality indicator report to the base station each second time interval when the mobility of the subscriber station is below the first threshold, wherein the second time interval is longer than the first time interval.

13. The method of claim 10, wherein the channel quality indicator averaging parameter increases when the mobility of the subscriber station increases.

14. The method of claim 10, wherein the channel quality indicator averaging parameter is received by the subscriber station in a downlink channel descriptor message or a channel quality indicator channel allocation information element in an uplink map.

15. A wireless communication system, comprising:
a subscriber station; and
a base station in communication with the subscriber station, wherein the base station is configured to:
determine mobility of the subscriber station; and
adjust a channel quality indicator averaging parameter based on the mobility of the subscriber station.

16. The wireless communication system of claim 15, wherein the base station is further configured to:
transmit the channel quality indicator averaging parameter to the subscriber station each first time interval when the mobility of the subscriber station is above a first threshold; and
transmit the channel quality indicator averaging parameter to the subscriber station each second time interval when the mobility of the subscriber station is below the first threshold, wherein the second time interval is longer than the first time interval.

17. The wireless communication system of claim 16, wherein the base station is further configured to:
determine the mobility of the subscriber station based on whether the subscriber station indicates mobility support is required, a frequency of downlink automatic repeat request window stall, or a frequency of downlink hybrid automatic repeat request negative acknowledgement.

18. The wireless communication system of claim 17, wherein the base station is further configured to:
receive a channel quality indicator report, wherein a frequency of the channel quality indicator report is based on the mobility support, the frequency of downlink automatic repeat request window stall, or the frequency of downlink hybrid automatic repeat request negative acknowledgement.

19. The wireless communication system of claim 18, wherein the base station is further configured to:
increase the channel quality indicator averaging parameter when the mobility of the subscriber station increases.

20. The wireless communication system of claim 19, wherein the base station is further configured to:
transmit the channel quality indicator averaging parameter to the subscriber station in a downlink channel descriptor message or a channel quality indicator channel allocation information element.
